(19) United States
(12) Patent Application Publication
(10) Pub. No.: US 2003/0143380 A1
(43) Pub. Date: Jul. 31, 2003

(54) Visible light energy emitting laminate for use in food packaging and method of producing

(76) Inventor: Jonathan P. Paul, Mound, MN (US)

Correspondence Address: GENERAL MILLS, INC., P.O. BOX 1113, MINNEAPOLIS, MN, 55440, US

(21) Appl. No.: 10/062,985

(22) Filed: Jan. 31, 2002

(51) Int. Cl. B32B 27/14

(52) U.S. Cl. 428/195.1

(57) ABSTRACT

The present invention is directed to a novel laminate used in the production of a food or other consumer package and having a light energy emitting printed or image fields as well as other printed or imaged fields, which emit no light energy. The laminate of the present invention prevents direct contact by such light emitting material with the contents of the particular package with which it is associated as well as the user of the particular package. The laminate may be used integrally as part of the package or may be applied directly to an external surface of a preformed package.

### CROSS-REFERENCES TO RELATED APPLICATIONS

None.

### BACKGROUND OF THE INVENTION

Today's marketplace presents the consumer with the daunting task of selecting goods that encompass a broad spectrum of choices. The typical consumer has is offered a wide variety of food and other retail packages that are available today in the marketplace, all of which are intended to serve a particular purpose, that of getting a consumer to purchase the particular product, which is contained within the package. While some products may not require any additional marketing initiative or promotional giveaways, other products use such messages and offer “premiums” to encourage the retail shopper to select one package over the other.

Such retail packages may take on different geometric shapes to distinguish the offering from other competitive products, may display a particular health message, such as an aid in lowering cholesterol or weight reduction, provide sweepstakes entries and other prize giveaways and the like.

The contents of such retail food products can take many forms and include cereal, yogurt, beverages, snacks, such as chips and nuts, sauces and creams, pastes and the like and lend themselves to a virtual myriad of packaging configurations.

As our society becomes increasingly mobile, there has been an upsurge in the number and types of food packages that customers can consume “on the go” or when it is otherwise inconvenient for a consumer to sit down and ingest a meal in what society may view as a conventional setting, i.e. sitting around a table. With the creation of such ready to eat (“RTE”) food products and their related packages, a difficulty arises in getting the consumer to notice the specific package in amongst competitive offerings. In addition, many promotional messages or premiums are not suitable for use with such packaging as the message or premium will come into direct contact with the mouth of the consumer or the food itself, as he or she ingest the contents of the package. More importantly, inks, coatings and the like have the possibility of separating from the package on which they are provided when subjected to chewing or other abrasive activity in the handling the package. Removal or loosening of the coatings or inks by such handling potentially exposes the consumer to health related risks of ingesting material which is not ordinarily intended to be consumed.

In addition to the foregoing difficulties, other problems are created due to strict governmental guidelines enacted to protect consumers from potentially hazardous materials found in the packaging. The use of ink, adhesives, resins and the like in packing food products is strictly regulated and in a number of instances, contact between the materials and the food is not permitted. In those few instances that do exist in which labels can be applied directly to the food product (for example, labels on bananas or other fruit), such labels do not readily lend themselves to other food packaging requirements for such ready to eat products or requirements for a particular marketing campaign.

As such, what is needed is a food package that can be used in delivering a food product in an attractive and competitive fashion while simultaneously over coming the difficulties enumerated above.

### BRIEF SUMMARY OF THE INVENTION

The present invention is directed to a novel package for a consumable food product. More specifically, the instant application is directed toward a food package having unique printed indicia that coincides with a particular event or promotion. The food package is printed or coated with a visible light energy emitting material such as ink, coatings or other substance such as a resin or other thermoplastic materials, that may posses some fluorescent, photo luminescent, chemical luminescent or similar property.

In one preferred embodiment of the present invention, a laminate is provided and is intended to be used in connection with a retail package for a food product. The laminate comprises at least first and second layers, with at least one of the first and second layers having first and second surfaces. One of the first and second surfaces is capable of receiving printing. A binder is disposed between the first and second layers to secure the first and second layers one to another. One of the first and second surfaces is capable of receiving printing and has first and second printable areas which are distinct from one another. The first printable area is imaged with an alphanumeric pattern and the second printable area is imaged with a non-alpha-numeric pattern. At least one the two patterns of one of the first and second areas is printed with an ink or other material which is capable of having visible light energy emitting properties.

In a still further embodiment of the present invention, includes a food package comprises a laminate has first and second layers and each of the layers are provided with first and second sides. A first region of one of the first and second sides of the first and second layers is receptive to a first printing and the first printing is confined to a first area. A second region of one of the first and second sides of the first and second layers is receptive to a second printing different than the first printing, the second printing is confined to a second area which is distinct from but complimentary to the first area. One of the first and second printings has a light energy emitting property and the first printing area is substantially confined within the second area.

A yet still further embodiment includes a method of printing a printable surface of a film, comprises the initial step of providing a film having first and second surfaces and first and second end edges and first and second longitudinally extending sides. Then printing on at least one of the first and second surfaces in a direction parallel to the longitudinally extending sides. A first set of images is produced having a first property on one of the first and second sides. A second set of images is created having a second property different from the first property on one of the first and second sides. A final step consists of applying light energy to each of the first and second set of images such that only one of the first and second properties absorbs the light energy such that only one of the first and second set of images emits the light energy to produce a visible set of images.

These and other objects of the invention will become clear from an inspection of the detailed description of the invention and from the appended claims.

### BRIEF DESCRIPTION OF THE DRAWINGS

The objects and advantages of this invention will be more completely understood and appreciated by referring to the following more detailed description of the presently preferred exemplary embodiments of the invention in conjunction with the accompanying drawings, of which:

FIG. 1 is a front view of the novel food package of the present invention;

FIG. 2 is a schematic view of the printing process; and

FIG. 3 illustrates a schematic side view of the laminate of the present invention.

### DETAILED DESCRIPTION OF THE INVENTION

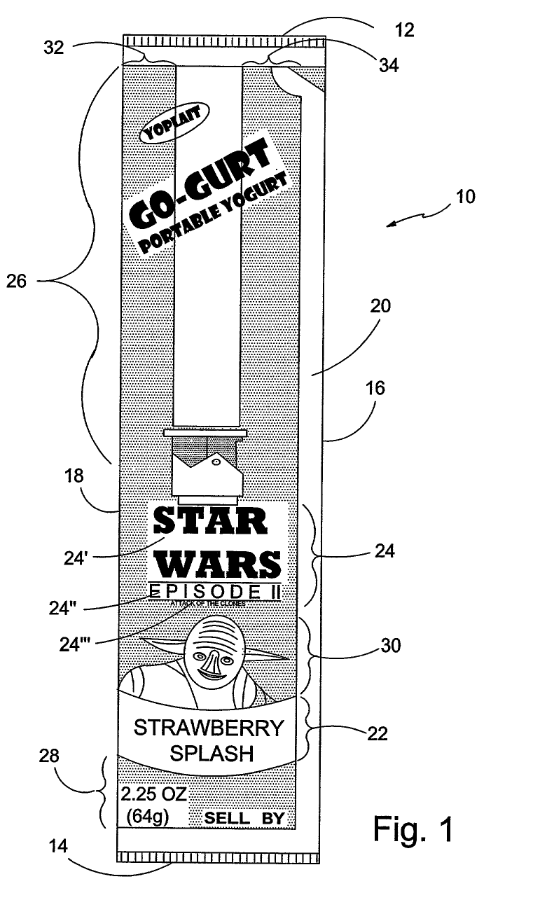

The invention of the instant application is illustrated and depicted generally by the reference to the package 10 in FIG. 1. While the illustration in the present embodiment is directed to a flexible film tube usable in providing ready to eat servings of yogurt, such as those offered under the trademarks GO-GURT® and EXPRESSE® available from General Mills, Inc. of Minneapolis, Minn., the scope and spirit of the invention is not to be so limited.

As used herein, the term retail package refers to any package which is sold or distributed through a retail environment or outlet, such as grocery and convenience stores, warehouse clubs, Internet based grocers, specialty stores and the like. The retail package can contain food, detergents, personal care products and other products intended for consumption or use.

The package 10 is provided with first and second end edges 12 and 14 each of which are sealed after the package has been filled with the contents. Package 10 has first and second longitudinally extending sides 16 and 18, which are disposed perpendicularly in the present embodiment to the end edges 12 and 14. That is, the end edges 12 and 14 extend in a direction which is transverse to the direction of the side edges. The longitudinally extending sides 16 and 18 in the present embodiment are substantially longer than the end edges 12 and 14 creating a rectangularly shaped package 10. However, other configurations and shapes are possible, such as a square, circle, triangle, pentagon, hexagon, etc.

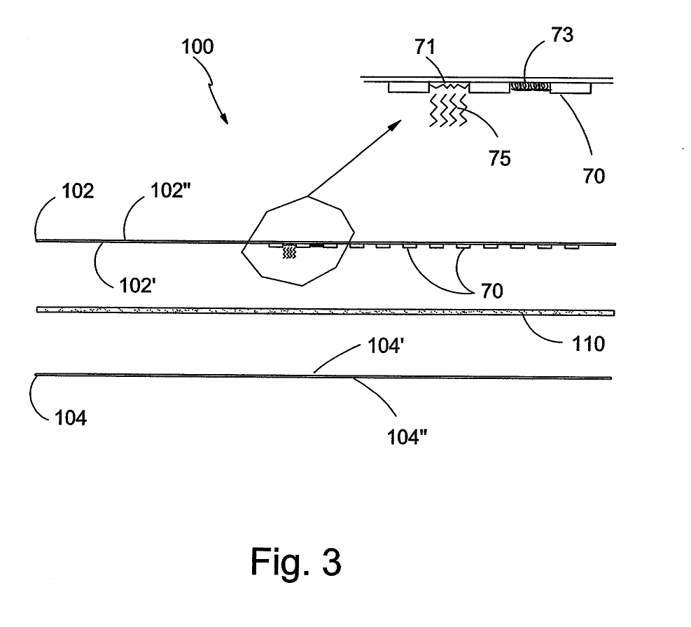

The package 10 of the preferred embodiment is constructed of a thermoplastic or heat sealable film such as polyester based films and resin like polyethylene terephthalate (PET). The package 10 is provided with a front panel 20 and a rear panel (not shown), which when sealed along the longitudinal edges 16 and 18, form a closure for a tube. For convenience, the printing or imaging regions 22, 24, 26, 28, 30, 32 and 34 of the laminate 100 depicted in FIG. 3 will be discussed in connection with the illustration provided in FIG. 1.

The front panel 20 is divided up into a number of printing or imaging regions or areas, 22, 24, 26, 28, 30, 32 and 34. While in the present invention, a number of printing or imaging areas or regions have been provided, any number of areas or regions to receive illustrations or indicia can be used to accommodate the design or marketing campaign. In manufacturing the present product, up to nine printing stations may be used. In the present embodiment, regions 22, 24 and 26 define printing or imaging regions or areas each of which is provided with an imaging or printing material that is different or distinct from the printing or imaging regions or areas illustrated at 28, 30, 32 and 34, collectively, in essence creating separate printing zones or defined printing regions. In the first printing area or region, the panel is provided with a material, which is capable of absorbing light energy and then emitting that absorbed light energy as a visible light. The second printing or imaging region or areas depicted by 28, 30, 32 and 34 are provided with a second printing or imaging material which is not capable of emitting light energy which is visible in the same range as the first imaging areas 22, 24 and 26.

In order to accomplish the objective of increasing sales of a particular product by constructing a package having a promotional or marketing theme, it is one of the objectives of the present invention that the first and second printing areas, defined respectively as 22, 24 and 26 and 28, 30, 32 and 34, are printed or imaged in a manner that the is complimentary to that of the other area. That is, the complimentary printing or imaging may comprise shading to “flesh out” or complete the trade dress associated with the character or scene, or it may include additional design elements, such as musical symbols, mythical creatures, ancient texts, etc. In addition, multiple themes can be conveyed to the consumer by only imprinting or imaging adjacent areas of the package 10 so as to create individual zones for each prospective message or pattern.

The printing or imaging provided in the first areas 22, 24 and 26 may comprise alphanumeric characters, geometric shapes such as rectangle, or other depictions of characters or illustrations which make up a particular feature or subject of the promotion surrounding the particular food/product package. For example, if the present invention were used with a cereal product, the character may be LUCKY THE LEPRECHAUN® and complimentary shapes may include the shaped marbits or marshmallow candy pieces found in the cereal LUCKY CHARMS®.

The printing or imaging provided in the second areas depicted by numerical references 28, 30, 32 and 34 may also be provided with alphanumeric imaging or printing as well as background coloration, illustrated in FIG. 1, or other characters, illustrations or geometric shapes which coincide with the particular promotional or marketing effort that coincides with the particular package.

In the illustration provided in FIG. 1, the particular promotion which is being provided in connection with the package 10 offering is one related to STAR WARS®, and the geometric depiction of printing area 26 is the illuminated end of a “light sabre.” The printing area 24 is provided with the printed indicia “STAR WARS® EPISODE II ATTACK OF THE CLONES®” in variable sized fonts 24′, 24″ and 24′″. Printing or imaging areas 32 and 34 are imaged with background colors which may be selected because of the promotion or to match the color of the food product provided in the package itself. In the present illustration, printing area 28 is provided with the background color as well as information pertinent to the contents, such as the expiration date and weight of the contents of the package 10. Printing area 30 is imaged with a character depiction, which may change to provide for collectability of the packages or to complement other portions of the promotion or marketing campaign.

The printing that is provided in such areas can be static, that is it remains fixed and unchanging from package to package or alternatively, variable printing or imaging can be provided on each package. Variable printing can be provided by a computer driven ion deposition printer such as available from Xerox Corporation, or through ink jet printers such as those available from Canon Corp. Ltd. Variable printing is accomplished by conventional technologies. By providing variable printing in connection with the packages, the manufacturer can change each package, create sweepstakes or prize notifications or provide other messages that the manufacturer or promoter may wish to deliver to the consumer. In addition, the manufacturer can provide batch and date information, which may differ from package to package.

While the present package 10 has been imaged with a particular character, the present invention is not intended to be so limiting and other characters, animals, scenery or inanimate objects may of course be used.

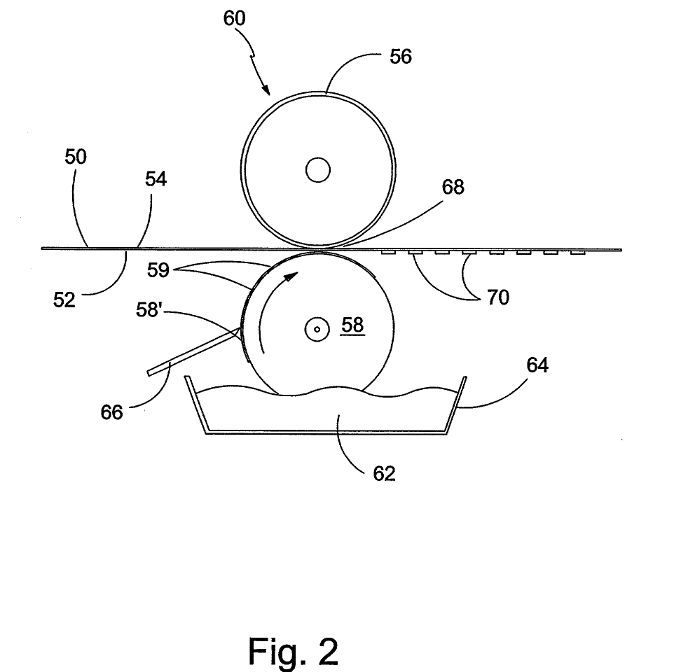

Turning now to FIG. 2, which illustrates the manner in which the printing of the laminate 100 (illustrated in FIG. 3) used in the package is accomplished. A polyester resin or film 50 (such as polyethylene terephthalate) has a first surface 52 and a second surface 54. The film 50 may be transparent or translucent or may be provided with areas having transparent or translucent strips to enable the image 70 on surface 102′ (illustrated in FIG. 3) to be viewed on the package. The second surface 54 may be provided with an ink receptive coating so as to bind the ink better to the surface or film 50 may be untreated. The film 50 is advanced to a first printing station depicted generally by reference numeral 60. The printing station 60 includes an impression roller 56 and a printing cylinder 58. The impression roller 56 is provided with a deformable surface, such as a rubber coating or mat, which serves to bias the film into the printing cylinder 58. The printing cylinder 58 is provided with a printing plate 58′. Ink or other imaging material 62 is supplied from a reservoir or fountain 64 directly to the printing plate 58′ and fills depressions 59 in the printing plate 58′. Excess ink is removed through the use of a doctor blade 66 which allows the ink 62 to return to the fountain or reservoir 64. After passing through the nip 68 created between the impression cylinder 56 and the printing cylinder 58 and printing plate 58′ the image 70 is transferred to the film 50 by depressing the film 50 into contact with the depressions 59 in the printing plate 58′.

The image 70 is reverse printed on the film 50 so that it may be viewed through the film 50 which may be transparent or translucent or have strips of transparent or translucent areas depending on the requirements of the packaging or marketing program.

Typically, one color or pattern is applied at the printing station 60 and where additional patterns or designs are provided such as with 22, 24, 26, 28, 30, 32 and 34 additional printing or imaging stations (not shown) are provided. In printing multiple patterns, a drier (not shown) may be used to dry the ink or other imaging material or petroleum based inks are used to expedite the drying process so that the film 50 can enter the next printing station.

The printing or imaging of the film 50 is accomplished in the longitudinal direction of the package 10 parallel to sides 16 and 18. The printing and filling of the package occur in same direction.

With reference to FIG. 3, the laminate, generally depicted by numeral 100 includes at least first and second layers 102 and 104. Layer 102 is composed of a polyester resin or film such as polyethylene terephthalate, which may be transparent or translucent or have portions of the film having these properties. Alternatively, the layer 102 may be mostly opaque if needed. Layer 104, which in the present illustration will be the layer, that is closest to the food contents of the package 10, is typically opaque and may be pigmented with various colors in order to compliment the marketing or promotional campaign. In the present example, the layer is pigmented with a white pigment. The intent is that layer 104 which also may be a thermoplastic film or polyester resin is to create an impervious barrier between the contents of the package 10 and any external material, which is not intended to contact the contents such as printing inks, adhesives, etc. The impervious layer 104 should be both gas and vapor impermeable and may be coated or sealed to achieve the appropriate characteristic. In addition, such pigmentation may serve to highlight the printing or imaging on layer 102.

Each of the layers 102 and 104 have first and second surfaces 102′ and 102″ and 104′ and 104″, respectively. In the illustration provided in FIG. 3, at least one surface of the two layers 102 and 104, here surface 102′ is a printable surface and has received the image 70 which was printed using the process and apparatus discussed above in reference to FIG. 2.

Disposed between the first surface 102 and the second surface 104 is a binder layer 110, which serves to tie or bind the two layers together to form the laminate 100. The binder layer 110 may be composed of adhesive (permanent acrylic, hot melt), a tie coating (such as polyvinyl alcohol) or other suitable medium that will form a permanent bond so that the layers 102 and 104 will not separate one from another after bonding. The image 70 on layer 102′ has first and second printed areas 71 and 73 which may contain different printed patterns such as that illustrated in FIG. 1 on package 10. In the present embodiment, one of the printed areas 71 is printed or imaged with a material, such as a fluorescent ink or resin which will emit light energy 75 after having been exposed to a light source and absorbed the energy from the light source.

The package 10 of the present invention, includes the laminate 100 depicted in FIG. 3. That is, the laminate 100 makes up the exterior panel 20 of the package and the laminate 100 is formed integrally with the package 10. The package 10 may be comprised of the laminate on both the front panel 20 and rear panel (not shown in FIG. 1) and after construction and sealing of the longitudinal sides 16 and 18 is transferred to a filling station using the apparatus referenced above.

The laminate of the present invention has been described as an integral part of the food package, which is suited for the delivery of a flowable product such as yogurt. Such a product is generally known as a yogurt tube and offered under the trademark GOGURT®. However, alternative uses are available for other products which are enclosed in a flexible film, such as FRUIT ROLL UPS®, candy and confectionary products and the like.

The laminate however can be used or applied directly to a prefabricated package, such as a cereal box, beverage container, baking mix, ready to eat meal containers, dough and biscuit tubs and containers and the like. In such application, one of the exposed surfaces 102″ or 104″ may be provided with an adhesive to secure the laminate to the package. In such a case, the laminate is not formed integrally with the package itself, but rather the laminate is juxtaposed on either external or internal surface of a food or retail package.

It will thus be seen according to the present invention a highly advantageous visible light energy emitting laminate for use with a food package or retail package has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

What we claim is:

1. A laminate to be used in connection with a retail package, comprising:
at least first and second layers, with one of said first and second layers having first and second surfaces, at least one of said first and second surfaces capable of receiving printing;
a binder disposed between said first and second layers to secure said first and second layers one to another;
said one of said first and second surfaces capable of receiving printing and having first and second printable areas;
said first printable area being imaged with an alpha-numeric pattern and said second printable area being imaged with a non-alpha-numeric pattern; and
wherein at least one the patterns of one of said first and second areas being printed with an ink having visible light energy emitting properties.

2. A laminate to be used in connection with a retail package as recited in claim 1, wherein at least a potion of said second area is imaged with a geometric pattern.

3. A laminate to be used in connection with a retail packages as recited in claim 1, wherein at least a portion of said second area is imaged with an illustration of a character.

4. A laminate to be used in connection with a retail package as recited in claim 1, wherein said at least one of said first and second layers is transparent.

5. A laminate to be used in connection with a retail package as recited in claim 1, wherein said at least one of said first and second layers is translucent.

6. A laminate to be used in connection with a retail package as recited in claim 1, wherein said first printable area is substantially contained within second printable area and said first and second printable areas are complimentary to one another.

7. A laminate to be used in connection with a retail package as recited in claim 1, wherein the retail package is a package that contains a food product.

8. A laminate to be used in connection with a retail package as recited in claim 7, wherein the package containing a food product is a flexible yogurt tube.

9. A laminate to be used in connection with a retail package as recited in claim 1, wherein said laminate is formed integrally with said retail package.

10. A laminate to be used in connection with a retail package as recited in claim 1, wherein said laminate is juxtaposed on but not integral with said retail package.

11. A laminate to be used in connection with a retail package as recited in claim 1, wherein at least one of said first and second layers is impervious to gas and vapors.

12. A food package, comprising;
a laminate having first and second layers, each of said layers having first and second sides;
a first region of one of said first and second sides of said first and second layers being receptive to a first printing, said first printing being confined to a first area;
a second region of one of said first and second sides of said first and second layers being receptive to a second printing different than said first printing, said second printing being confined to a second area distinct from but complimentary to said first area;
one of said first and second printings having a light energy emitting property; and
wherein said first area is substantially confined within said second area.

13. A food package as recited in claim 12, wherein said first printing has a light energy emitting property.

14. A food package as recited in claim 12, wherein said second printing comprises background and static information printing.

15. A food package as recited in claim 14, wherein said second printing includes variably printed information.

16. A food package as recited in claim 12, wherein said food package is a yogurt tube.

17. A method of printing a printable surface of a film, comprising;
providing a film having first and second surfaces and first and second end edges and first and second longitudinally extending sides;
printing on at least one of said first and second surfaces in a direction parallel to said longitudinally extending sides;
producing a first set of images having a first property on said one of said first and second sides;
creating a second set of images having a second property different from said first property on one of said first and second sides; and
applying light energy to each of said first and second set of images such that only one of said first and second properties absorbs the light energy such that only one of said first and second sets of images emits said light energy producing a visible set of images.

18. A method of printing a printable surface of a film as recited in claim 16, wherein the printing is done in reverse.

19. A method of printing a printable surface of a film as recited in claim 17 wherein said first and second images are applied adjacent to one another.
